(19) United States
(12) Patent Application Publication
(10) Pub. No.: US 2021/0017428 A1
(43) Pub. Date: Jan. 21, 2021

(54) ELECTROCONDUCTIVE ADHESIVE COMPOSITION

(71) Applicant: TANAKA KIKINZHOKU KOGYO K.K., Tokyo (JP)

(72) Inventors: Shintaroh ABE, The Cavendish (SG); Takeshi KONDO, Kanagawa (JP); Maki WATANABE, Kanagawa (JP)

(73) Assignee: TANAKA KIKINZHOKU KOGYO K.K., Tokyo (JP)

(21) Appl. No.: 16/981,125

(22) PCT Filed: Mar. 27, 2019
(86) PCT No.: PCT/JP2019/013450

§ 371 Date: Sep. 15, 2020

(30) Foreign Application Priority Data
Mar. 30, 2018 (JP) 2018-068688

(51) Int. Cl. C09J 9/02; C09J 11/04; H01B 1/22

(52) U.S. Cl. CPC C09J 9/02; H01B 1/22; C09J 11/04

(57) ABSTRACT

The purpose of the present invention is to provide an electroconductive adhesive composition having excellent thermal conductivity and migration resistance. The present invention relates to an electroconductive adhesive composition containing an electroconductive filler (A) including silver powder (a1) and silver-coated copper powder (a2), and a binder composition (B), wherein the electroconductive adhesive composition contains 3-65% by mass of the silver-coated copper powder (a2) with respect to the entire amount of the electroconductive filler (A), and contains 95-99.95% by mass of the electroconductive filer (A) with respect to the total quantity of nonvolatile components in the electroconductive adhesive composition.

### TECHNICAL FIELD

The present invention relates to an electrically conductive adhesive composition.

### BACKGROUND ART

In an electronic component, an electrically conductive adhesive composition is used as a die bonding material for the adhesion/bonding of a semiconductor element to a support member such as lead frame. In the electrically conductive adhesive composition, a metal powder such as silver powder and copper powder is generally used because of its high electrical conductivity, and a number of reports on an adhesive containing the metal powder or a pasty adhesive that effects adhesion through sintering have been made.

Here, the demand for a miniaturized and highly functionalized electronic component such as power device or light-emitting diode (LED) is rapidly growing in recent years, and with the progress of miniaturization of an electronic component, the amount of heat generated by a semiconductor element tends to increase. In this connection, when a semiconductor element is exposed to a high temperature environment for a long period of time, its original functions cannot be displayed or the service life thereof is shortened.

Accordingly, high thermal conductivity is required of a die bonding material so as to efficiently dissipate heat generated from the semiconductor element to the support member, and the required level therefor is continuing to rise.

To meet the requirement above, there has been reported an electrically conductive adhesive composition where in order to enhance the thermal conductivity, among others, silver having excellent thermal conductivity is used as an electrically conductive filler and the content thereof is increased.

However, due to the low migration resistance of silver and the increased content of the electrically conductive filler, the above-described electrically conductive adhesive composition is disadvantageous in that particularly, migration is likely to occur.

In consideration of this issue, an electrically conductive adhesive composition using, as an electrically conductive filler, a silver-coated copper having excellent migration resistance has been reported.

For example, Patent Literature 1 discloses an electrical component in which connection between components is established by means of a thermally conductive composition including from 90 to 99 wt % of an electrically conductive particle containing a substantially spherical silver-coated copper powder and a silver fine powder, with the ratio of the substantially spherical silver-coated copper powder and the silver fine powder (substantially spherical silver-coated copper powder:silver fine powder) being from 95:5 to 55:45 in terms of volume ratio.

### CITATION LIST

### Patent Literature

Patent Literature 1: Japanese Patent No. 5,609,492

### SUMMARY OF INVENTION

### Technical Problem

However, the thermal conductivity of the silver-coated copper is poor compared with silver and consequently, sufficient thermal conductivity may not be obtained with an electrically conductive adhesive composition using a silver-coated copper as an electrically conductive filler.

In Examples of Patent Literature 1, an electrically conductive composition having a thermal conductivity of 35 to 58 w/mK is disclosed, but due to a recent increase in the required level for thermal conductivity, an electrically conductive adhesive composition having a higher thermal conductivity is desired.

As described above, it is difficult to satisfy the thermal conductivity and the migration resistance at the same time, and therefore, an electrically conductive adhesive composition having both high thermal conductivity and excellent migration resistance is demanded.

The present invention has been invented in consideration of the problem above, and an object thereof is to provide an electrically conductive adhesive composition exhibiting excellent thermal conductivity and further having excellent migration resistance.

### Solution to Problem

As a result of intensive studies, the present inventors have found that when in an electrically conductive adhesive composition including an electrically conductive filler (A) containing a silver powder (a1) and a silver-coated copper powder (a2), and a binder composition (B), the contents of the silver-coated copper powder (a2) and the binder composition (B) are set to appropriate ranges, the object above can be attained. The present invention has been accomplished based on this finding.

More specifically, the electrically conductive adhesive composition of the present invention is an electrically conductive adhesive composition including an electrically conductive filler (A) containing a silver powder (a1) and a silver-coated copper powder (a2), and a binder composition (B), wherein the electrically conductive adhesive composition contains from 3 to 65 mass % of the silver-coated copper powder (a2) relative to the overall amount of the electrically conductive filler (A) and from 95 to 99.95 mass % of the electrically conductive filler (A) relative to the total amount of nonvolatile components in the electrically conductive adhesive composition.

In the electrically conductive adhesive composition according to one embodiment of the present invention, the silver powder (a1) contains a silver powder having an average particle diameter of 0.5 to 20 μm and a silver powder having an average particle diameter of 10 to 200 nm.

In the electrically conductive adhesive composition according to one embodiment of the present invention, the electrically conductive filler (A) contains from 5 to 50 mass % of a silver powder having an average particle diameter of 10 to 200 nm.

The cured electrically conductive adhesive of the present invention is obtained by curing the electrically conductive adhesive composition according to any one above.

In the electronic device of the present invention, the electrically conductive adhesive composition according to any one above is used for the adhesion of a component.

### Advantageous Effects of Invention

The electrically conductive adhesive composition of the present invention is excellent in the thermal conductivity and electrical conductivity and further has excellent migration resistance.

### DESCRIPTION OF EMBODIMENTS

Embodiments for implementing the present invention are described below, but the present invention is not limited to the following embodiments and can be implemented by making any modification without departing from the gist of the present invention.

In the present description, the “to” indicating a numerical range is used in the sense that the numerical values described before and after it are included as the lower limit value and the upper limit value.

In the present description, the “average particle diameter” of the silver powder (a1S) having an average particle diameter on the nanometer order means the 50% average particle diameter (D50) in a particle diameter distribution measured using a dynamic light scattering method and can be measured using, for example, Nanotrac manufactured Nikkiso Co., Ltd.

In addition, the “average particle diameter of a component except for the silver powder (a1S) having an average particle diameter on the nanometer order means the 50% average particle diameter (D50) in a particle diameter distribution measured using a laser diffraction/scattering particle size analyzer and can be measured using, for example, a laser diffraction/scattering particle size analyzer, MT-3000, manufactured by Nikkiso Co., Ltd.

### [Electrically Conductive Adhesive Composition]

The electrically conductive adhesive composition of the present invention contains an electrically conductive filler (A) and a binder composition (B). The components constituting the electrically conductive adhesive composition of the present invention are described below.

### <Electrically Conductive Filler (A)>

The electrically conductive filler (A) is a component contributing to electrical conductivity of the electrically conductive adhesive composition. In the electrically conductive adhesive composition of the present invention, in order to obtain good thermal conductivity and electrical conductivity, the content of the electrically conductive filler (A) is set to be 95 mass % or more relative to the total amount of nonvolatile components in the electrically conductive adhesive composition. The content of the electrically conductive filler (A) is preferably 97 mass % or more, more preferably 98 mass % or more, relative to the total amount of nonvolatile components in the electrically conductive adhesive composition.

Furthermore, in the electrically conductive adhesive composition of the present invention, in order to facilitate paste formation of the electrically conductive adhesive composition, the content of the electrically conductive filler (A) is set to be 99.95 mass % or less relative to the total amount of nonvolatile components in the electrically conductive adhesive composition. The content of the electrically conductive filler (A) is preferably 99.90 mass % or less, more preferably 99 mass % or less, relative to the total amount of nonvolatile components in the electrically conductive adhesive composition.

Here, the nonvolatile component in the electrically conductive adhesive composition is, out of components contained in the electrically conductive adhesive composition, a component that does not volatilize even after curing, and the electrically conductive filler (A) and the binder composition (B) come under this nonvolatile component.

(Silver Powder (a1))

In the present invention, the electrically conductive filler (A) contains a silver powder (a1). The content of the silver powder (a1) is not particularly limited, but in view of thermal conductivity, the content of the silver powder (a1) relative to the overall amount of the electrically conductive filler (A) is preferably 40 mass % or more, more preferably 45 mass % or more, still more preferably 50 mass % or more, and most preferably 55 mass % or more. Furthermore, in view of migration resistance, the content of the silver powder (a1) relative to the overall amount of the electrically conductive filler (A) is preferably 95 mass % or less, more preferably 90 mass % or less, still more preferably 85 mass % or less, and most preferably 80 mass % or less.

In the present invention, the silver powder (a1) may be composed of one kind of a silver powder but may be composed of two or more kinds of silver powders differing in the shape or average particle diameter, and above all, it is preferable to contain a silver powder (a1S) having an average particle diameter on the nanometer order and a silver powder (a1L) having an average particle diameter on the micrometer order.

As for the silver powder (a1L) having an average particle diameter on the micrometer order (hereinafter, sometimes simply referred to as “silver powder (a1L)”), in order to prevent shrinkage after curing of the electrically conductive adhesive composition and enhance the adhesiveness to an adherend material, the average particle diameter thereof is preferably 0.5 μm or more, more preferably 1 μm or more, still more preferably 2 μm or more.

Furthermore, in order to make the progress of sintering of the silver powder (a1L) difficult and enhance the adhesiveness to an adherend material, the average particle diameter of the silver powder (a1L) is preferably 20 μm or less, more preferably 10 μm or less, still more preferably 5 μm or less.

The shape of the silver powder (a1L) is not particularly limited and includes, for example, powdery, spherical, flaky, foil-like, plate-like and dendritic shapes. The shape is generally flaky or spherical.

The silver powder (a1S) having an average particle diameter on the nanometer order (hereinafter, sometimes simply referred to as “silver powder (a1S)”) is usually coated with the later-described coating agent for the purpose of preventing aggregation, and in order to facilitate the removal of the coating agent and make the sintering easily proceed, the average particle diameter is preferably 10 nm or more, more preferably 30 nm or more, still more preferably 50 nm or more.

On the other hand, if the average particle diameter of the silver powder (a1S) is excessively large, the specific surface area of the silver powder (a1 S) is reduced and sintering becomes difficult to proceed. Accordingly, the average particle dimeter of the silver powder (a1S) is preferably 200 nm or less, more preferably 150 nm or less, still more preferably 100 nm or less.

The shape of the silver powder (a1S) is not particularly limited, and a silver powder having the same shape as those exemplified in the description of the shape of the silver powder (a1L) may be used, but the shape is generally flaky or spherical.

Both of the contents of silver powder (a1L) and silver powder (a1S) contained in the electrically conductive filler (A) in the present invention are not particularly limited, but by increasing the content of the silver powder (a1S), a dense structure can be achieved in a cured product obtained by curing the electrically conductive adhesive composition and consequently, among others, high thermal conductivity and electrical conductivity can be achieved. On the other hand, from the viewpoint of enhancing the coatability of the electrically conductive adhesive composition, the content of the silver powder (a1S) is preferably smaller. Accordingly, the content of each of the silver powder (a1L) and the silver powder (a1S) is preferably in the following range.

That is, the content of the silver powder (a1L) relative to the overall amount of the electrically conductive filler (A) is preferably 20 mass % or more, more preferably 30 mass % or more, still more preferably 40 mass % or more, a most preferably 45 mass % or more. In addition, the content of the silver powder (a1L) relative to the overall amount of the electrically conductive filler (A) is preferably 95 mass % or less, more preferably 90 mass % or less, still more preferably 85 mass % or less, and most preferably 80 mass % or less.

The content of the silver powder (a1S) relative to the overall amount of the electrically conductive filler (A) is preferably 5 mass % or more, more preferably 10 mass % or more, still more preferably 15 mass % or more. In addition, the content of the silver powder (a1S) relative to the overall amount of the electrically conductive filler (A) is preferably 50 mass % or less, more preferably 40 mass % or less, still more preferably 30 mass % or less.

(Silver-Coated Copper Powder (a2))

The silver-coated copper powder (a2) in the present invention is not particularly limited as long as it is a copper powder having a silver coating on the surface, and, for example, a commercially available silver-coated copper powder can be used.

The silver-coated copper powder is a component enhancing the migration resistance of the electrically conductive adhesive composition, and in the present invention, in order to obtain sufficient migration resistance, the content of the silver-coated copper powder (a2) relative to the overall amount of the electrically conductive filler (A) is set to be 3 mass % or more. Furthermore, in order to obtain higher migration resistance, the content of the silver-coated copper powder (a2) relative to the overall amount of the electrically conductive filler (A) is preferably 5 mass % or more, more preferably 10 mass % or more, still more preferably 20 mass % or more, and most preferably 30 mass % or more.

On the other hand, since the copper-coated copper powder (a2) has poor thermal conductivity compared with the silver powder (a1), if the content of the silver-coated copper powder is increased, the thermal conductivity of the electrically conductive adhesive composition is reduced. Therefore, in the present invention, in order to obtain sufficient thermal conductivity, the content of the silver-coated copper powder (a2) relative to the overall amount of the electrically conductive filler (A) is set to be 65 mass % or less. Furthermore, in order to obtain higher thermal conductivity, the content of the silver-coated copper powder (a2) relative to the overall amount of the electrically conductive filler (A) is preferably 60 mass % or less, more preferably 55 mass % or less, still more preferably 50 mass % or less, and most preferably 45 mass % or less.

The average particle diameter of the silver-coated copper powder (a2) is not particularly limited, but for the reason that by increasing the particle diameter, the number of silver/copper interfaces per electrically conductive path can be reduced and the thermal conductivity can be more improved, the average particle diameter is preferably 1 μm or more, more preferably 2 μm or more, still more preferably 5 μm or more.

Furthermore, in view of coating properties such as dispensing, the average particle diameter of the silver-coated copper powder (a2) is preferably 20 μm or less, more preferably 15 μm or less, still more preferably 10 μm or less.

The shape of the silver-coated copper powder (a2) is not particularly limited, and a silver-coated copper powder having the same shape as those exemplified in the description of the shape of the silver powder (a1L) may be used, but the shape is generally flaky or spherical.

The content of the silver-coated copper powder (a2) is not particularly limited but is usually on the order of 5 to 30 mass % and preferably from 10 to 30 mass %.

In addition, the coating with silver may be partial coating, or the entirety of the copper powder may be coated with silver. The method for coating with silver is also not particularly limited, but, for example, the coating may be formed by plating, etc.

### (Another Component)

The electrically conductive adhesive composition of the present invention may contain a component (hereinafter, sometimes referred to as “another filler”) other than the silver powder (a1) and silver-coated copper powder (a2) as long as the effects of the present invention are produced. The another filler is not particularly limited if it has electrical conductivity, and those known as an electrically conductive filler can be used.

The surface of the component above constituting the electrically conductive filler (A) of the present invention may be coated with a coating agent. When the surface of the component above constituting the electrically conductive filler (A) is coated with a coating agent, the dispersibility with the binder composition (B) is enhanced, and this makes paste formation easy. The coating agent includes, for example, a coating agent containing a carboxylic acid. By using a coating agent containing a carboxylic acid, the heat dissipation property of the electrically conductive adhesive composition can be further enhanced.

As the coating agent, a stearic acid, an oleic acid, etc. is used in general.

The method for coating the surface of the electrically conductive filler (A) with a coating agent includes known methods, for example, a method in which both the filler and the coating agent are stirred and kneaded together in a mixer, and a method in which the electrically conductive filler (A) is impregnated with a solution of a carboxylic acid and the solvent is volatilized.

### <Binder Composition (B)>

In the electrically conductive adhesive composition of the present invention, the electrically conductive filler (A) is dispersed in a binder composition (B). The binder composition (B) may contain a binder resin, a curing agent, a curing accelerator, a diluent, etc.

In the present invention, the content of the binder composition (B) is not particularly limited, but in order to obtain good thermal conductivity and electrical conductivity, the content is preferably 5 mass % or less, more preferably 3 mass % or less, sill more preferably 2 mass % or less, relative to the total amount of nonvolatile components in the electrically conductive adhesive composition.

Furthermore, in order to obtain good coatability and adhesive strength, the content of the binder composition (B) is preferably 0.05 mass % or more, more preferably 0.1 mass % or more, sill more preferably 1 mass % or more, relative to the total amount of nonvolatile components in the electrically conductive adhesive composition.

The binder resin is not particularly limited, but, for example, an epoxy resin, a phenol resin, a urethane resin, an acrylic resin, a silicone resin, or a polyimide resin, etc. may be used, and one of these may be used alone, or a plurality of kinds thereof may be used in combination. In view of operation efficiency, the binder resin in the present invention is preferably a thermosetting resin, more preferably an epoxy resin.

The content of the binder resin is preferably 0.04 mass % or more relative to the total amount of nonvolatile components in the electrically conductive adhesive composition, because stable adhesive strength can be obtained. The content of the binder resin is more preferably 0.08 mass % or more, still more preferably 0.2 mass % or more, and most preferably 0.5 mass % or more, relative to the total amount of nonvolatile components in the electrically conductive adhesive composition. On the other hand, in order to ensure thermal conductivity, the content of the binder resin is preferably 4.8 mass % or less, more preferably 2.8 mass % or less, still more preferably 2.5 mass % or less, and most preferably 2.0 mass % or less, relative to the total amount of nonvolatile components in the electrically conductive adhesive composition.

The curing agent is a component for curing the binder resin, and, for example, an amine-based curing agent such as tertiary amine, alkyl urea and imidazole, and a phenolic curing agent, etc. may be used. As for the curing agent, only one kind of a curing agent may be used, or two or more kinds of curing agents may be used in combination. The content of the curing agent is not particularly limited but is preferably 1 mass % or less relative to the total amount of nonvolatile components in the electrically conductive adhesive composition, and in this case, the curing agent is less likely to remain uncured and the adhesiveness to an adherend material is improved.

The curing accelerator is a component for accelerating the curing of the binder resin, and, for example, imidazoles such as 2-phenyl-4,5-dihydroxymethylimidazole, 2-phenyl-4-methyl-5-hydroxymethylimidazole, 2-methyl-4-methylimidazole and 1-cyano-2-ethyl-4-methylimidazole, tertiary amines, triphenylphosphines, urea compounds, phenols, alcohols, and carboxylic acids, etc. can be used. As for the curing accelerator, only one kind of a curing accelerator may be used, or two or more kinds of curing accelerators may be used in combination. The content of the curing accelerator is not particularly limited and may be appropriately determined, but usually, the content is 0.2 mass % or less relative to the total amount of nonvolatile components in the electrically conductive adhesive composition.

The diluent is a component for diluting the binder resin. Although it is not particularly limited, a reactive diluent is preferably used, and, for example, 1,4 butanediol diglycidyl ether, neopentyl diglycidyl ether, etc. may be used. As for the diluent, only one kind of a diluent may be used, or two or more kinds of diluents may be used in combination. The content of the diluent is not particularly limited but, for example, is preferably from 0.1 to 1.5 mass %, more preferably from 0.3 to 1.2 mass %, relative to the total amount of nonvolatile components in the electrically conductive adhesive composition. In this case, the viscosity of the electrically conductive adhesive composition falls within a favorable range.

Besides the components above, as long as the effects of the present invention are not impaired, for example, a thermoplastic resin can be incorporated into the binder composition (B). The thermoplastic resin includes, for example, a phenoxy resin, an amide resin, polyester, polyvinyl butyral, and ethyl cellulose, etc.

### <Other Components>

In addition to the electrically conductive filler (A) and the binder composition (B), as long as the effects of the present invention are not impaired, other components may be incorporated into the electrically conductive adhesive composition of the present invention. Other components include, for example, a solvent, an antioxidant, an ultraviolet absorber, a tackifier, a viscosity regulator, a dispersant, a coupling agent, a toughening agent, an elastomer, etc.

Incorporation of a solvent into the electrically conductive adhesive composition of the present invention facilitates paste formation. The solvent is not particularly limited, but in order for the solvent to be readily volatilized at the time of curing of the electrically conductive adhesive composition, a solvent having a boiling point of 350° C. or less is preferred, and a solvent having a boiling point of 300° C. or less is more preferred. Specifically, the solvent includes an acetate, an ether, a hydrocarbon, etc., and more specifically, butyl triglycol, dibutyl carbitol, butyl carbitol acetate, etc., are preferably used. The content of the solvent is not particularly limited, but in the case of incorporating a solvent, the content thereof is preferably from 0.5 to 20 mass %, more preferably from 1.0 to 10 mass %, relative to the overall amount of the electrically conductive adhesive composition.

The electrically conductive adhesive composition of the present invention can be obtained by mixing and stirring, in an arbitrary order, the above-described electrically conductive (A) and binder composition (B) as well as, if incorporated, other components. The method for mixing is not particularly limited, and, for example, systems such as two-roll, three-roll, sand mill, roll mill, ball mill, colloid mill, jet mill, bead mill, kneader, homogenizer and propellerless mixer can be employed.

### [Bonding Method]

In the case where adhesion is performed using the electrically conductive adhesive composition of the present invention, the adhesion is usually effected by curing the electrically conductive adhesive composition under heating. At this time, the heating temperature is not particularly limited, but in order to form a close-contact state between the electrically conductive fillers (A) and between an adherend material and the electrically conductive filler (A) such that these are brought into point contact with each other, and thereby stabilize the shape as an adhesion part, the temperature is preferably 100° C. or more, more preferably 130° C. or more, still more preferably 150° C. or more.

In addition, for the purpose of avoiding that mutual bonding of the electrically conductive fillers (A) excessively proceeds and necking occurs between the electrically conductive fillers (A) to firmly bond the electrically conductive fillers (A) to each other and produce an excessively hardened state, the temperature during curing is preferably 250° C. or less, more preferably 230° C. or less, still more preferably 210° C. or less.

The strength of the bonding obtained using the electrically conductive adhesive composition of the present invention can be evaluated by various methods and, for example, can be evaluated using the bonding strength measured by the method described later in the paragraph of Examples. The preferable bonding strength varies depending on the use, etc., but, for example, in the case of a chip of 2 mm×2 mm described in Examples, the bonding strength is preferably 150 N or more, more preferably 200 N or more. The bonding strength per unit area is preferably 37 N/mm² or more, more preferably 50 N/mm² or more.

The electrical conductivity of the cured electrically conductive adhesive (hereinafter, sometimes simply referred to as “cured product”) obtained by curing the electrically conductive adhesive composition of the present invention can also be evaluated by various methods and, for example, can be evaluated using the volume resistivity measured by the method described later in the paragraph of Examples. The preferable volume resistivity varies depending on the use, etc., but in order to ensure electrical conductivity of an adherend material, the volume resistivity of the cured product obtained by curing the electrically conductive adhesive composition of the present invention is, for example, preferably less than 30 μΩcm, more preferably less than 10 μΩcm.

The thermal conductivity of the cured product obtained by curing the electrically conductive adhesive composition of the present invention can also be evaluated by various methods and, for example, can be evaluated using the thermal conductivity measured by the method described later in the paragraph of Examples. The preferable thermal conductivity varies depending on the use, etc., but the thermal conductivity of the cured product obtained by curing the electrically conductive adhesive composition of the present invention is, for example, preferably 75 W/m·K or more, more preferably 100 W/m·K or more.

The migration resistance of the cured product obtained by curing the electrically conductive adhesive composition of the present invention can also be evaluated by various methods and, for example, can be evaluated by the method described later in the paragraph of Examples. The preferable migration resistance varies depending on the use, etc., but, for example, the current value measured by the method described later in the paragraph of Examples is preferably less than 10 mA, more preferably less than 1 mA.

The electrically conductive adhesive composition of the present invention is not particularly limited in its usage but can be used, for example, for the adhesion of a component in an electronic device.

### Examples

The present invention is described more specifically below by referring to Examples, however, the present invention is not limited by these Examples in any way.

### A. Preparation of Electrically Conductive Adhesive Composition

Nonvolatile components contained in the electrically conductive adhesive compositions of Examples and Comparative Examples are shown in Tables 1 and 2. 100 Parts by mass of these nonvolatile components and 6.1 parts by mass of a solvent (butyl triglycol) that is a volatile component were mixed in the order of the binder composition (B), the solvent, and the electrically conductive filler (A) in a propellerless mixer and then kneaded in a three-roll mill to prepare electrically conductive adhesive compositions having the compositions shown in Tables 1 and 2. The numerical value in each column of Tables indicates the following.

### Column of Each Component Name:

The content (mass %) of each component relative to the total amount of nonvolatile components in the electrically conductive adhesive composition.

### Column “(A) Total”:

The total content (mass %) of the electrically conductive filler (A) relative to the total amount of nonvolatile components in the electrically conductive adhesive composition.

### Column “(B) Total”:

The total content (mass %) of the binder composition (B) relative to the total amount of nonvolatile components in the electrically conductive adhesive composition.

Column “Ratio (%) of (a2)”:

The content (mass %) of the silver-coated copper powder (a2) relative to the total content of the electrically conductive filler (A).

Column “Ratio (%) of (a1S)”;

The content (mass %) of the silver powder (a1S) relative to the total content of the electrically conductive filler (A).

### [Electrically Conductive Filler (A)]

Silver powder (a1L):

Flaky, average particle diameter d50: 3 μm
Silver powder (a1S):

Spherical, average particle diameter d50: 50 nm
Silver-coated copper powder (a2):

Flaky, average particle diameter d50: 6 μm, silver content: 20 mass %
Copper powder:

Spherical, average particle diameter d50: 5.5 μm
Solder powder:

Spherical, average particle diameter d50: 5 μm

### [Binder Composition (B)]

Binder resin 1:

“Kane Ace (registered trademark) MX-136” (trade name), produced by Kaneka Corporation, liquid at room temperature
Binder resin 2:

“EPALLOY (registered trademark) 8330” (trade name), produced by Emerald Performance Materials, liquid at room temperature
Binder resin 3:

“ADEKA RESIN (registered trademark) EP-3950L” (trade name), produced by ADEKA Corporation, liquid at room temperature
Diluent:

Difunctional reactive diluent (Adeka Glycirol (registered trademark) ED-523L, produced by ADEKA Corporation)
Curing agent:

Phenolic curing agent (ME180001, produced by Meiwa Plastic Industries, Ltd.)
Curing accelerator:

2-Phenyl-4,5-dihydroxymethylimidazole (2PHZ, produced by Shikoku Chemicals Corporation)

### B. Evaluation of Physical Properties

A PPF-plated copper lead frame of 12 mm×12 mm was coated with the electrically conductive adhesive composition obtained and after placing a silver-sputter-coated silicon chip of 2 mm×2 mm on the coated surface, heated at 230° C. for 60 minutes in an air atmosphere to prepare a metal-bonded body in which the PPF-plated copper lead frame and the silver-sputter-coated silicon chip are bonded via a cured electrically conductive adhesive (hereinafter, sometimes simply referred to as “metal-bonded body”). The following evaluations were performed using the resulting metal-bonded body.

### <Bonding Strength>

The bonding strength at room temperature was obtained by subjecting the resulting metal-bonded body to a fracture test which was performed using Bond Tester 4000 manufactured by Nordson Advance Technology K.K. at room temperature. In addition, the bonding strength was evaluated based on the following criteria according to the obtained bonding strength value. The results are shown in Tables 1 and 2.

### (Evaluation Criteria)

A (good): 200 N or more

B (slightly good): 150 N or more and less than 200 N

C (poor): less than 150 N

### <Volume Resistivity>

The obtained electrically conductive adhesive composition obtained was applied, in a rectangular shape with a width of 5 mm and a length of 50 mm, onto a glass substrate and heated at 230° C. for 60 minutes to obtain a cured electrically conductive adhesive (hereinafter, sometimes simply referred to as “cured product”). The resulting cured product was cooled to room temperature and measured for the resistance value at both ends in the length direction. Subsequently, the thickness of the cured product was measured, and the volume resistivity was determined from the resistance values and thickness. Furthermore, the volume resistivity was evaluated based on the following criteria according to the obtained volume resistivity value. The results are shown in Tables 1 and 2.

### (Evaluation Criteria)

A (good): less than 10 μΩcm

B (slightly good): 10 μΩcm or more and less than 30 μΩcm

C (poor): 30 μΩcm or more

### <Thermal Conductivity>

With respect to the obtained electrically conductive adhesive of the metal-bonded body, the thermal diffusion a was measured using a laser flash method thermal constant measurement system (“LFA467HT” (trade name), manufactured by NETZSCH) in conformity with ASTM-E1461, the room-temperature specific gravity d was computed by the pycnometer method, the room-temperature specific heat Cp was measured using a differential scanning calorimeter (“DSC7020” (trade name), manufactured by Seiko Instruments & Electronics Ltd.) in conformity with JIS-K7123:2012, and the thermal conductivity λ (W/m·K) was calculated according to the relational expression λ=a×d×Cp. In addition, the thermal conductivity was evaluated based on the following criteria according to the obtained thermal conductivity λ value. The results are shown in Tables 1 and 2.

### (Evaluation Criteria)

A (good): 100 W/m·K or more

B (slightly good): 75 W/m·K or more and less than 100 W/m·K

C (poor): less than 75 W/m·K

### <Migration Resistance>

The migration resistance was evaluated as follows by a water drop test.

That is, first, the obtained electrically conductive adhesive composition was printed on a glass substrate with use of a metal mask and cured by heating at 200° C. for 90 minutes to prepare counter electrodes with an interelectrode distance of 2 mm, a width of 10 mm, a length of 10 mm, and a thickness of 50 μm. Subsequently, a voltage of 5 V was applied between electrodes, 20 μL of distilled water in a cylindrical cap provided directly above a gap between electrodes was dropped between electrodes, and after 300 seconds, the current value was measured. In addition, the migration resistance was evaluated based on the following criteria according to the current value obtained. The results are shown in Tables 1 and 2.

### (Evaluation Criteria)

A (good): less than 1 mA

B (slightly good): 1 mA or more and less than 10 mA

C (poor): 10 mA or more

TABLE 1

| | | Example | | | | | | | | | |
|---|---|---|---|---|---|---|---|---|---|---|---|
| | | 1 | 2 | 3 | 4 | 5 | 6 | 7 | 8 | 9 | 10 |
| Electrically | Silver powder (a1L) | 73.5 | 63.7 | 53.9 | 44.1 | 78.4 | 34.3 | 24.5 | 54.5 | 52.8 | 68.6 |
| conductive | Silver powder (a1S) | 14.7 | 14.7 | 14.7 | 14.7 | 14.7 | 14.7 | 14.7 | 14.9 | 14.4 | 0.0 |
| filler (A) | Silver-coated copper | 9.8 | 19.6 | 29.4 | 39.2 | 4.9 | 49.0 | 58.8 | 29.7 | 28.8 | 29.4 |
| | powder (a2) | | | | | | | | | | |
| | Copper powder | 0.0 | 0.0 | 0.0 | 0.0 | 0.0 | 0.0 | 0.0 | 0.0 | 0.0 | 0.0 |
| | Solder powder | 0.0 | 0.0 | 0.0 | 0.0 | 0.0 | 0.0 | 0.0 | 0.0 | 0.0 | 0.0 |
| | (A) Total | 98.0 | 98.0 | 98.0 | 98.0 | 98.0 | 98.0 | 98.0 | 99.0 | 96.0 | 98.0 |
| | Ratio of (a2) (%) | 10 | 20 | 30 | 40 | 5 | 50 | 60 | 30 | 30 | 30 |
| | Ratio of (a1S) (%) | 15 | 15 | 15 | 15 | 15 | 15 | 15 | 15 | 15 | 0 |
| Binder composition | Binder resin 1 | 0.6 | 0.6 | 0.6 | 0.6 | 0.6 | 0.6 | 0.6 | 0.3 | 1.2 | 0.6 |
| (B) | Binder resin 2 | 0.3 | 0.3 | 0.3 | 0.3 | 0.3 | 0.3 | 0.3 | 0.2 | 0.6 | 0.3 |
| | Binder resin 3 | 0.1 | 0.1 | 0.1 | 0.1 | 0.1 | 0.1 | 0.1 | 0.1 | 0.2 | 0.1 |
| | Diluent | 0.6 | 0.6 | 0.6 | 0.6 | 0.6 | 0.6 | 0.6 | 0.3 | 1.2 | 0.6 |
| | Curing agent | 0.3 | 0.3 | 0.3 | 0.3 | 0.3 | 0.3 | 0.3 | 0.2 | 0.6 | 0.3 |
| | Curing accelerator | 0.1 | 0.1 | 0.1 | 0.1 | 0.1 | 0.1 | 0.1 | 0.1 | 0.2 | 0.1 |
| | (B) Total | 2.0 | 2.0 | 2.0 | 2.0 | 2.0 | 2.0 | 2.0 | 1.0 | 4.0 | 2.0 |
| Bonding strength | Measured value (N) | 225 | 211 | 224 | 210 | 220 | 170 | 150 | 150 | 160 | 155 |
| | Rating | A | A | A | A | A | B | B | B | B | B |
| Volume resistivity | Measured value (μΩcm) | 4.8 | 5.4 | 6.7 | 7.7 | 4.8 | 9.0 | 15.0 | 6.0 | 11.0 | 8.1 |
| | Rating | A | A | A | A | A | A | B | A | B | A |
| Thermal conductivity | Measured value (W/m · K) | 145 | 140 | 135 | 100 | 150 | 90 | 80 | 130 | 95 | 98 |
| | Rating | A | A | A | A | A | B | B | A | B | B |
| Migration resistance | Measured value (mA) | 4.07 | 0.11 | 0.09 | 0.09 | 7.35 | 0.07 | 0.05 | 0.09 | 0.09 | 0.10 |
| | Rating | B | A | A | A | B | A | A | A | A | A |

TABLE 2

| | | Comparative Example | | | | |
|---|---|---|---|---|---|---|
| | | 1 | 2 | 3 | 4 | 5 |
| Electrically | Silver powder (a1L) | 83.3 | 53.9 | 53.9 | 14.7 | 51.7 |
| conductive | Silver powder (a1S) | 14.7 | 14.7 | 14.7 | 14.7 | 14.1 |
| filler (A) | Silver-coated copper powder | 0.0 | 0.0 | 0.0 | 68.6 | 28.2 |
| | (a2) | | | | | |
| | Copper powder | 0.0 | 29.4 | 0.0 | 0.0 | 0.0 |
| | Solder powder | 0.0 | 0.0 | 29.4 | 0.0 | 0.0 |
| | (A) Total | 98.0 | 98.0 | 98.0 | 98.0 | 94.0 |
| | Ratio of (a2) (%) | 0 | 0 | 0 | 70 | 30 |
| | Ratio of (a1S) (%) | 15 | 15 | 15 | 15 | 15 |
| Binder composition (B) | Binder resin 1 | 0.6 | 0.6 | 0.6 | 0.6 | 1.8 |
| | Binder resin 2 | 0.3 | 0.3 | 0.3 | 0.3 | 0.9 |
| | Binder resin 3 | 0.1 | 0.1 | 0.1 | 0.1 | 0.3 |
| | Diluent | 0.6 | 0.6 | 0.6 | 0.6 | 1.8 |
| | Curing agent | 0.3 | 0.3 | 0.3 | 0.3 | 0.9 |
| | Curing accelerator | 0.1 | 0.1 | 0.1 | 0.1 | 0.3 |
| | (B) Total | 2.0 | 2.0 | 2.0 | 2.0 | 6.0 |
| Bonding strength | Measured value (N) | 225 | 218 | 6 | 130 | 135 |
| | Rating | A | A | C | B | B |
| Vo1ume resistivity | Measured value (μΩcm) | 4.7 | 8.5 | 146.7 | 30.0 | 15.0 |
| | Rating | A | A | C | C | B |
| Thermal conductivity | Measured value (W/m · K) | 160 | 90 | 10 | 45 | 72 |
| | Rating | A | B | C | C | C |
| Migration resistance | Measured value (mA) | 22.45 | 28.6 | 4.6 | 0.03 | 0.08 |
| | Rating | C | C | B | A | A |

In Examples 1 to 10 which are the electrically conductive adhesive composition of the present invention, all of the bonding strength, volume resistivity, thermal conductivity and migration resistance were excellent.

On the other hand, in Comparative Example 1 which does not contain the silver-coated copper powder (a2), the migration resistance was poor.

In Comparative Example 2 where a copper powder is incorporated in place of the silver-coated copper powder (2) of the electrically conductive adhesive composition of Example 3, the migration resistance was poor.

In Comparative Example 3 where a solder powder is incorporated in place of the silver-coated copper powder (a2) of the electrically conductive adhesive composition of Example 3, the bonding strength, volume resistivity and thermal conductivity were poor.

In Comparative Example 4 where the content of the silver-coated copper powder (a2) relative to the overall amount of the electrically conductive filler (A) is 70 mass %, the thermal conductivity was poor.

In Comparative Example 5 where the content of the electrically conductive filler (A) relative to the total amount of nonvolatile components in the electrically conductive adhesive composition is 94 mass %, the thermal conductivity was poor.

While the invention has been described in detail and with reference to specific embodiments thereof, it will be apparent to one skilled in the art that various changes and modifications can be made therein without departing from the spirit and scope thereof. This application is based on a Japanese patent application filed on Mar. 30, 2018 (Patent Application No. 2018-068688), the entirety of which is incorporated herein by way of reference. All references cited herein are incorporated by reference herein in their entirety.

1. An electrically conductive adhesive composition comprising an electrically conductive filler (A) containing a silver powder (a1) and a silver-coated copper powder (a2), and a binder composition (B), wherein the electrically conductive adhesive composition contains from 3 to 65 mass % of the silver-coated copper powder (a2) relative to the overall amount of the electrically conductive filler (A), and
from 95 to 99.95 mass % of the electrically conductive filler (A) relative to the total amount of nonvolatile components in the electrically conductive adhesive composition.

2. The electrically conductive adhesive composition according to claim 1, wherein the silver powder (a1) contains a silver powder having an average particle diameter of 0.5 to 20 μm and a silver powder having an average particle diameter of 10 to 200 nm.

3. The electrically conductive adhesive composition according to claim 2, wherein the electrically conductive adhesive composition contains from 5 to 50 mass % of the silver powder having an average particle diameter of 10 to 200 nm relative to the overall amount of the electrically conductive filler (A).

4. A cured electrically conductive adhesive obtained by curing the electrically conductive adhesive composition according to claim 1.

5. An electronic device in which the electrically conductive adhesive composition according to claim 1 is used for the adhesion of a component.
